(19) United States
(12) Patent Application Publication
(10) Pub. No.: US 2026/0136122 A1
(43) Pub. Date: May 14, 2026

(54) EARPHONES

(71) Applicant: SHENZHEN SHOKZ CO., LTD., Shenzhen (CN)

(72) Inventors: Chu WANG, Shenzhen (CN); Jianhua XIE, Shenzhen (CN); Yunbin CHEN, Shenzhen (CN)

(73) Assignee: SHENZHEN SHOKZ CO., LTD., Shenzhen (CN)

(21) Appl. No.: 19/435,850

(22) Filed: Dec. 30, 2025

Related U.S. Application Data
(63) Continuation of application No. PCT/CN2024/131355, filed on Nov. 11, 2024.

(51) Int. Cl. H04R 1/10; H04R 1/02; H04R 3/00

(52) U.S. Cl. CPC H04R 1/1016; H04R 1/02; H04R 3/00

(57) ABSTRACT

The present disclosure relates to an earphone including a first housing assembly, a second housing assembly, a metal member, a radio frequency (RF) circuit, and an electrical connector, wherein two ends of the metal member are respectively connected to the first housing assembly and the second housing assembly; the first housing assembly forms an accommodating cavity and includes a connecting portion, one end of the metal member is disposed in the connecting portion; the RF circuit is disposed in the accommodating cavity, one end of the electrical connector is connected to the RF circuit and the other end of the electrical connector is spaced apart from the metal member; and an RF signal output from the RF circuit is loaded onto the metal member in an electromagnetic coupling manner via the electrical connector.

### CROSS REFERENCE TO RELATED APPLICATIONS

This application is a continuation of International Application No. PCT/CN2024/131355 filed on Nov. 11, 2024, the entire contents of which are incorporated herein by reference.

### TECHNICAL FIELD

The present disclosure generally relates to the field of electronic devices, and in particular, to earphones.

### BACKGROUND

With the continuous popularization of electronic devices, the electronic devices have become indispensable social and entertainment tools in people's daily lives. People have increasingly higher requirements for the electronic devices. Electronic devices such as earphones have been widely used in people's daily lives. They can be used with terminal devices such as mobile phones and computers to provide users with an auditory feast. According to the working principle, the earphones can generally be divided into air conduction earphones and bone conduction earphones. According to the wearing manner, the earphones can generally be divided into over-ear earphones, ear-clip earphones, and in-ear earphones. According to the interaction manner between the earphones and the electronic devices, the earphones can generally be divided into wired earphones and wireless earphones. In existing earphones equipped with an antenna assembly, a specific absorption ratio (SAR) value of the antenna assembly is large, and the antenna performance is poor, which greatly affects the user experience of using the earphones.

### SUMMARY

One or more embodiments of the present disclosure provide an earphone. The earphone includes a first housing assembly, a second housing assembly, a metal member, a radio frequency (RF) circuit, and an electrical connector, wherein two ends of the metal member are respectively connected to the first housing assembly and the second housing assembly; the first housing assembly forms an accommodating cavity and includes a connecting portion, one end of the metal member is disposed in the connecting portion; the RF circuit is disposed in the accommodating cavity, one end of the electrical connector is connected to the RF circuit and the other end of the electrical connector is spaced apart from the metal member; and an RF signal output from the RF circuit is loaded onto the metal member in an electromagnetic coupling manner via the electrical connector.

Beneficial effects of the present disclosure are as follows. The electrical connector and the metal member cooperate to serve as an antenna assembly of the earphone, enabling the earphone to transmit or receive an antenna signal. The electrical connector serves as an antenna branch. The metal member is electromagnetically coupled with the electrical connector to serve as an antenna body. Based on this configuration, on one hand, the metal member can effectively disperse a current generated based on the RF signal on the electrical connector, thereby preventing the current generated based on the RF signal from being entirely concentrated on the electrical connector, and thus effectively reducing the SAR value of the antenna assembly. On the other hand, the metal member is located between the first housing assembly and the second housing assembly and is not easily blocked by other components (e.g., a circuit board and a battery assembly disposed in the first housing assembly) of the earphone. Therefore, using the metal member as the antenna body can effectively increase the clearance of the antenna assembly, thereby effectively improving the antenna performance of the antenna assembly. Furthermore, directly connecting the electrical connector to the metal member requires surface treatment on the metal member. This not only increases processing difficulty of the metal member, but the surface treatment can also cause material alteration of the metal member, making the metal member brittle, thereby reducing the structural strength of the metal member and affecting the operational stability of the metal member. Compared with directly connecting the electrical connector to the metal member, loading the RF signal onto the metal member in the electromagnetic coupling manner via the electrical connector eliminates the need for the surface treatment on the metal member. This not only effectively reduces the processing difficulty of the metal member, but also effectively improves the operational stability of the metal member.

It should be understood that the foregoing general description and the following detailed description are exemplary and explanatory only and are not restrictive of the present disclosure.

### BRIEF DESCRIPTION OF THE DRAWINGS

To more clearly illustrate the technical solutions in the embodiments of the present disclosure, the drawings used in the description of the embodiments will be briefly introduced below. Obviously, the drawings in the following description are only some embodiments of the present disclosure. For those of ordinary skill in the art, other drawings may be obtained based on these drawings without creative efforts.

FIG. 1 is a front schematic diagram of an earphone after being worn on an ear of a person with large ears or small ears according to an embodiment of the present disclosure.

FIG. 2 is a three-dimensional structural schematic diagram of the earphone shown in FIG. 1.

FIG. 3 is an exploded structural schematic diagram of an ear hook portion and an abutting portion of the earphone shown in FIG. 2.

FIG. 4 is a three-dimensional structural schematic diagram of the earphone shown in FIG. 2 with a first sub-housing removed.

FIG. 5 is a three-dimensional structural schematic diagram of a connecting portion shown in FIG. 3.

FIG. 6 is a schematic diagram of a relative positional relationship between a coupling end of an electrical connector and a coupling end of a metal member shown in FIG. 3 according to a first embodiment.

FIG. 7 is a schematic diagram of a relative positional relationship between the coupling end of the electrical connector and the coupling end of the metal member shown in FIG. 3 according to a second embodiment.

FIG. 8 is a schematic diagram of a relative positional relationship between the coupling end of the electrical connector and the coupling end of the metal member shown in FIG. 3 according to a third embodiment.

FIG. 9 is a schematic diagram of a structure of the coupling end of the electrical connector and the coupling end of the metal member shown in FIG. 8 in a direction A according to a third embodiment.

FIG. 10 is a schematic diagram of a relative positional relationship between the coupling end of the electrical connector and the coupling end of the metal member shown in FIG. 3 according to a fourth embodiment.

### DETAILED DESCRIPTION

The following describes the present disclosure in further detail with reference to the drawings and embodiments. It is specifically pointed out that the following embodiments are only used to illustrate the present disclosure, but do not limit the scope of the present disclosure. Similarly, the following embodiments are only some embodiments of the present disclosure rather than all embodiments. All other embodiments obtained by a person of ordinary skill in the art based on the embodiments of the present disclosure without creative efforts shall fall within the protection scope of the present disclosure.

Mention of “embodiment” in the present disclosure means that a specific feature, structure, or characteristic described in connection with the embodiment may be included in at least one embodiment of the present disclosure. A person skilled in the art explicitly and implicitly understands that the embodiments described in the present disclosure may be combined with other embodiments.

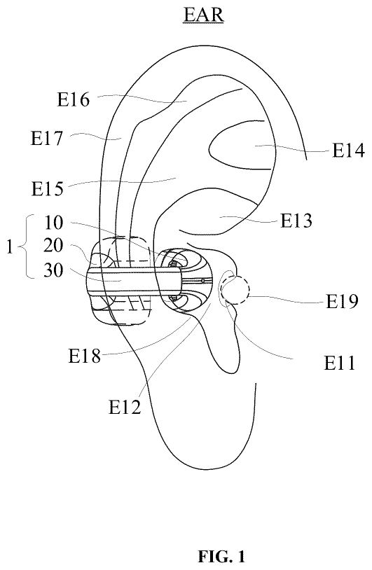

Referring to FIG. 1, an ear of a user may include physiological parts such as an external auditory canal E11, a concha cavity E12, a cymba conchae E13, a triangular fossa E14, an antihelix E15, a scapha E16, a helix E17, and an antitragus E18. Although the external auditory canal E11 has a certain depth and extends to a tympanic membrane of the ear, for ease of description and referring to FIG. 1, the external auditory canal E11 in the present disclosure specifically refers to an entrance (i.e., an ear hole) of the external auditory canal E11 away from the tympanic membrane unless otherwise specified. Further, the physiological parts such as the concha cavity E12, the cymba conchae E13, and the triangular fossa E14 have a certain volume and depth. The concha cavity E12 is directly connected to the external auditory canal E11, that is, the ear hole is simply regarded as being located at a bottom of the concha cavity E12.

Further, the ear further includes a tragus E19 around the external auditory canal. Compared with the concha cavity E12, the cymba conchae E13, the triangular fossa E14, and other parts that have a certain depth and volume in three-dimensional space (i.e., these parts are recessed toward a back side of the ear along a direction close to the head of the user), the tragus E19 protrudes toward a front side of the ear along a direction away from the head of the user. “The front side of the ear” is a concept relative to “the back side of the ear,” the former refers to a side of the ear away from the head, for example, as shown in FIG. 1; the latter refers to a side of the ear toward the head, both are directed at the ear of the user.

Further, different users may have individual differences, resulting in differences in a shape, a size, and other dimensions of the ear. For ease of description and to reduce (or even eliminate) the individual differences of different users, for ease of description and understanding, unless otherwise specified, the present disclosure will mainly use an ear model with a “standard” shape and size as a reference to further describe wearing manners of acoustic devices on the ear model in different embodiments. For example, a simulator (e.g., GRAS 45BC KEMAR) including a head and ears (a left ear and a right ear) thereof may be manufactured based on ANSI: S3.36, S3.25 and IEC: 60318-7 standards, and be regarded as a reference for wearing the acoustic device to present a scenario in which most users normally wear the acoustic device. Merely by way of example, the ear as the reference may have the following related features. A size of a projection of an auricle on a sagittal plane in a direction of a vertical axis may be in a range of 49.5 mm to 74.3 mm, and a size of the projection of the auricle on the sagittal plane in a direction of a sagittal axis may be in a range of 36.6 mm to 55 mm. Therefore, in the present disclosure, descriptions such as “a wearer wears,” “in a wearing state,” and “in the wearing state” may mean that the acoustic device described in the present disclosure is worn on an ear of the foregoing simulator. Certainly, considering the individual differences of the different users, a structure, a shape, a size, a thickness, etc., of one or more parts in the ear may be different. To meet needs of the different users, the acoustic device may be differentially designed. These differential designs may be reflected in that characteristic parameters of one or more structures (e.g., a sound generation portion 10, an ear hook portion 30, etc.) in the acoustic device may have values in different ranges to adapt to different ears.

It should be noted that in fields such as medicine and anatomy, three basic sections (i.e., the sagittal plane, a coronal plane, and a horizontal plane) and three basic axes (i.e., the sagittal axis, a coronal axis, and the vertical axis) of a human body may be defined. The sagittal plane refers to a section made along an anteroposterior direction of the human body and perpendicular to the ground, which divides the human body into a left part and a right part. The coronal plane refers to a section made along a left-right direction of the human body and perpendicular to the ground, which divides the human body into a front part and a back part. The horizontal plane refers to a section made along an up-down direction of the human body and parallel to the ground, which divides the human body into an upper part and a lower part. Correspondingly, the sagittal axis refers to an axis along the anteroposterior direction of the human body and perpendicular to the coronal plane. The coronal axis refers to an axis along the left-right direction of the human body and perpendicular to the sagittal plane. The vertical axis refers to an axis along the up-down direction of the human body and perpendicular to the horizontal plane. Further, “the front side of the ear” described in the present disclosure is a concept relative to “the back side of the ear,” the former refers to a side of the ear away from the head, for example, as shown in FIG. 1; the latter refers to a side of the ear toward the head, both are directed at the ear of the user. When the ear of the foregoing simulator is observed along a direction of the coronal axis of the human body, a front side outline diagram of the ear shown in FIG. 1 may be obtained.

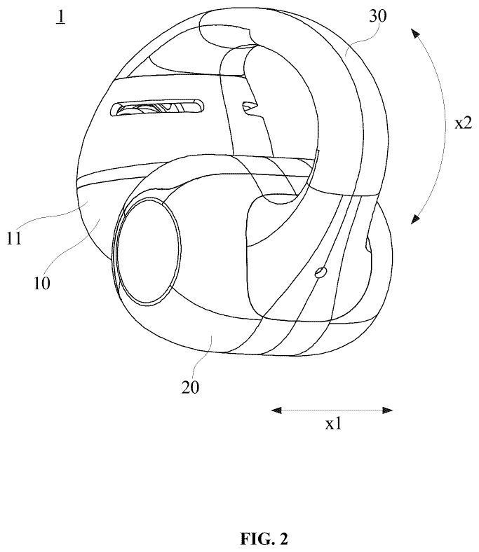

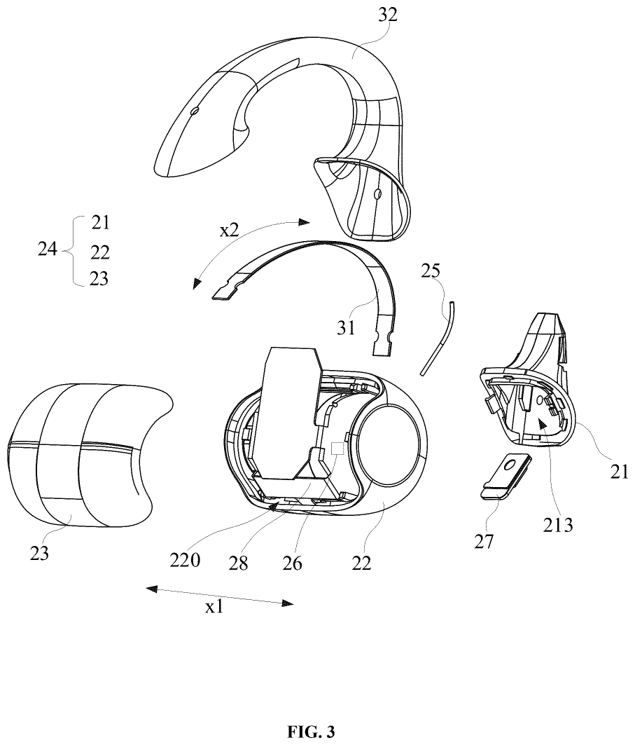

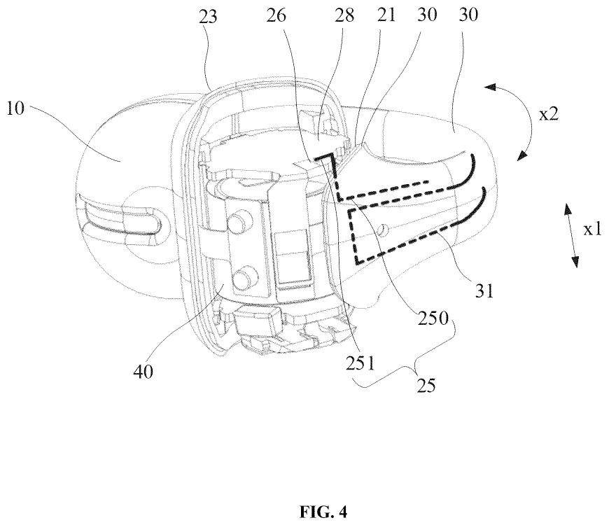

As shown in FIG. 2, FIG. 3, and FIG. 4, the present disclosure provides an earphone 1. The earphone 1 includes a first housing assembly 24, a second housing assembly 11, a metal member 31, a radio frequency (RF) circuit 26, and an electrical connector 25. Two ends of the metal member 31 are respectively connected to the first housing assembly 24 and the second housing assembly 11. The first housing assembly 24 forms an accommodating cavity 220 and includes a connecting portion 21. One end of the metal member 31 (also referred to as a coupling end 310 of the metal member 31) is disposed in the connecting portion 21. The RF circuit 26 is disposed in the accommodating cavity 220. One end of the electrical connector 25 (also referred to as a connecting end of the electrical connector 25) is connected to the RF circuit 26. The other end of the electrical connector 25 (also referred to as a coupling end 250 of the electrical connector 25) is spaced apart from the metal member 31. An RF signal output from the RF circuit 26 is loaded on the metal member 31 in an electromagnetic coupling manner via the electrical connector 25.

The electrical connector 25 and the metal member 31 cooperate with each other to serve as an antenna assembly of the earphone 1, so that the earphone 1 can transmit or receive an antenna signal. The electrical connector 25 serves as an antenna branch of the antenna assembly. The metal member 31 is electromagnetically coupled with the electrical connector 25 to serve as an antenna body of the antenna assembly. Based on this configuration, the metal member 31 can effectively disperse a current generated based on the RF signal on the electrical connector 25, thereby preventing the current generated based on the RF signal from being entirely concentrated on the electrical connector 25, and thus effectively reducing the SAR value of the antenna assembly. An antenna length of the antenna assembly is equal to a sum of a length of the electrical connector 25, a length of the metal member 31, and an equivalent electrical length of a coupling capacitance between the electrical connector 25 and the metal member 31.

While the metal member 31 serves as a connecting member connecting the first housing assembly 24 and the second housing assembly 11, the metal member 31 is also reused as the antenna body of the antenna assembly. Compared with a solution in which an additional component is configured as an antenna, using the metal member 31 as the antenna body of the antenna assembly can effectively reduce a quantity of components of the earphone 1, thereby effectively saving costs of the earphone 1. The first housing assembly 24 and the second housing assembly 11 are usually provided with one or more of functional components such as a circuit board 28, a battery assembly 40, and a sound generation assembly. Therefore, there are many components and compact space inside the first housing assembly 24 and the second housing assembly 11 (e.g., the accommodating cavity 220). If the entire antenna assembly is disposed in the first housing assembly 24 or the second housing assembly 11, a clearance of the antenna assembly is greatly affected, thereby affecting antenna performance of the antenna assembly. The metal member 31 is located between the first housing assembly 24 and the second housing assembly 11 and is not easily blocked by other components of the earphone 1. Therefore, using the metal member 31 as the antenna body can effectively increase the clearance of the antenna assembly, thereby effectively improving the antenna performance of the antenna assembly. In addition, directly connecting the electrical connector 25 to the metal member 31 requires surface treatment on the metal member 31. This not only increases processing difficulty of the metal member 31, but the surface treatment also causes material alteration of the metal member 31, making the metal member 31 brittle, thereby reducing the structural strength of the metal member 31 and affecting the operational stability of the metal member 31. Compared with directly connecting the electrical connector 25 to the metal member 31, loading the RF signal onto the metal member 31 in the electromagnetic coupling manner via the electrical connector 25 eliminates the need for the surface treatment on the metal member 31. This can not only effectively reduce the processing difficulty of the metal member 31, but also effectively improve the operational stability of the metal member 31.

As shown in FIG. 4, the coupling end 310 of the metal member 31 is disposed in the connecting portion 21 to connect to the first housing assembly 24. The connecting portion 21 is a part of the first housing assembly 24, and the RF circuit 26 is disposed in the accommodating cavity 220 of the first housing assembly 24. This allows the RF circuit 26 to be disposed closer to an end of the metal member 31 that is electromagnetically coupled to the electrical connector 25, thereby effectively reducing arrangement difficulty of the electrical connector 25.

One or both of the first housing assembly 24 and the second housing assembly 11 may be provided with a corresponding sound generation assembly to form the sound generation portion 10 of the earphone 1. The metal member 31 is a main connecting component in the ear hook portion 30 connecting the first housing assembly 24 and the second housing assembly 11. The metal member 31 may be an elastic component with flexibility. The metal member 31 may provide an auxiliary function for wearing the earphone 1 to improve wearing stability. In some embodiments, the ear hook portion 30 further includes an elastic coating layer 32 coating the metal member 31 and the connecting portion 21.

As shown in FIG. 1, FIG. 2, FIG. 3, and FIG. 4, in some embodiments, the earphone 1 is a clip-on earphone. The earphone 1 includes the sound generation portion 10, an abutting portion 20, and the ear hook portion 30 connecting the sound generation portion 10 and the abutting portion 20. The earphone 1 further includes a sound generation assembly (not shown) disposed in the second housing assembly 11. In a wearing state, the second housing assembly 11 is disposed in the concha cavity E12. The first housing assembly 24 abuts against a back side of the auricle. The metal member 31 is wound around a periphery of a helix. The metal member 31 is arranged in a sheet form. One main surface of the metal member 31 faces the auricle. The other main surface of the metal member 31 faces away from the auricle. Specifically, as shown in FIG. 3, components such as the battery assembly 40, the circuit board 28, and a microphone 27 are disposed in the accommodating cavity 220 of the first housing assembly 24 to serve as the abutting portion 20 of the earphone 1. The RF circuit 26 is disposed on the circuit board 28. Components (e.g., the sound generation assembly) are disposed in the second housing assembly 11 to serve as the sound generation portion 10 of the earphone 1. In the wearing state, the sound generation portion is disposed in the concha cavity E12. The second housing assembly 11 serves as the abutting portion 20 of the earphone 1 and abuts against the back side of the auricle. The metal member 31 is wound around the periphery of the helix and is an elastic metal member to provide a clamping force for the first housing assembly 24 and the second housing assembly 11, so that the first housing assembly 24 and the second housing assembly 11 can cooperate with each other to clamp, and thus the entire earphone 1 is clamped on the ear. In the wearing state, the metal member 31 is wound around the periphery of the helix, which can effectively increase a distance between the antenna body (i.e., the metal member 31) and the user's head, thereby reducing the absorption of the antenna signal by the head, and thus effectively improving the antenna performance of the antenna assembly.

In some embodiments, the earphone 1 may also be an ear-hook earphone 1. The earphone 1 includes two sound generation portions 10 and the ear hook portion 30 connecting the two sound generation portions 10. The sound generation assemblies are disposed in the first housing assembly 24 and the second housing assembly 11 to serve as the two sound generation portions 10 of the earphone 1, respectively. The earphone 1 further includes the ear hook portion 30 connecting the two sound generation portions 10. The ear hook portion 30 includes the metal member 31. The earphone 1 can be worn in a hanging manner through the ear hook portion 30. The metal member 31 provides an elastic force for the ear hook portion 30, so that the earphone 1 can be stably hung on the head or the ear of the user.

Optionally, as shown in FIG. 3 and FIG. 4, the coupling end 250 of the electrical connector 25 is disposed in the connecting portion 21. A connecting end 251 of the electrical connector 25 extends into the accommodating cavity 220 and is connected to the RF circuit 26. The connecting portion 21 is a part of the first housing assembly 24 for connecting to the metal member 31. The coupling end 250 of the electrical connector 25 is disposed in the connecting portion 21. In this way, the connecting portion 21 can provide structural support for the coupling end 250 of the electrical connector 25 to better fix the coupling end 250. Since the coupling end 310 of the metal member 31 is also disposed in the connecting portion 21, a coupling coefficient k (referring to Formula \textcircled{1} below) of the electromagnetic coupling between the coupling end 250 and the metal member 31 exhibits relatively small fluctuation and relatively superior consistency.

In some embodiments, the coupling end 250 of the electrical connector 25 may also be in the accommodating cavity 220. The coupling end 310 of the metal member 31 may extend from the connecting portion 21 into the accommodating cavity 220 to be spaced apart from the electrical connector 25 to implement the electromagnetic coupling.

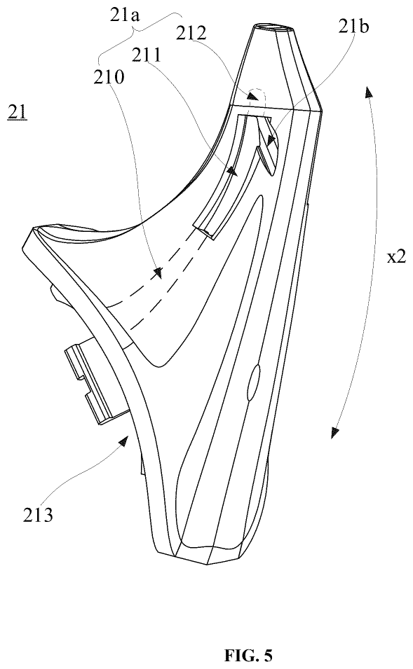

Optionally, as shown in FIG. 5, an insertion cavity 21a communicating with the accommodating cavity 220 is pre-formed on the connecting portion 21. The coupling end 250 of the electrical connector 25 is inserted into the insertion cavity 21a. A relative positional relationship between the coupling end 250 of the electrical connector 25 and the coupling end 310 of the metal member 31 is one of key factors affecting the electromagnetic coupling between the electrical connector 25 and the metal member 31. The relative positional relationship between the coupling end 250 of the electrical connector 25 and the coupling end 310 of the metal member 31 needs to be kept relatively stable, so that the electrical connector 25 and the metal member 31 can stably implement the electromagnetic coupling. Therefore, by providing the insertion cavity 21a on the connecting portion 21 and disposing the coupling end 250 of the electrical connector 25 in the insertion cavity 21a, the insertion cavity 21a can limit and fix the coupling end 250 of the electrical connector 25 to reduce a probability that the relative positional relationship between the coupling end 250 of the electrical connector 25 and the coupling end 310 of the metal member 31 changes, thereby providing a structural basis for stable electromagnetic coupling between the electrical connector 25 and the metal member 31, and effectively improving the operational stability of the antenna assembly.

The coupling end 250 of the electrical connector 25 is limited in the insertion cavity 21a. The relative positional relationship between the coupling end 250 of the electrical connector 25 and the coupling end 310 of the metal member 31 is determined by a positional relationship between the insertion cavity 21a and the coupling end 310 of the metal member 31. Therefore, a spatial arrangement between the coupling end 250 of the electrical connector 25 and the coupling end 310 of the metal member 31 can be pre-arranged by arranging the positional relationship between the insertion cavity 21a and the coupling end 310 of the metal member 31. In this way, a step of the spatial arrangement between the coupling end 250 of the electrical connector 25 and the coupling end 310 of the metal member 31 can be advanced to a molding process of the connecting portion 21. Compared with arranging the positional relationship between the coupling end 250 of the electrical connector 25 and the coupling end 310 of the metal member 31 in an assembly process of the earphone 1, by arranging the positional relationship between the coupling end 250 of the electrical connector 25 and the coupling end 310 of the metal member 31 in the molding process of the connecting portion 21, a spatial arrangement difficulty between the coupling end 250 of the electrical connector 25 and the coupling end 310 of the metal member 31 can be effectively reduced, and a spatial arrangement accuracy can be effectively improved.

Optionally, as shown in FIG. 5, an auxiliary cavity 21b communicating with the insertion cavity 21a and crossing the insertion cavity 21a is pre-formed on the connecting portion 21. The auxiliary cavity 21b is formed by a first insert. The first insert is configured to fix a second insert for forming the insertion cavity 21a during the molding process of the connecting portion 21. Specifically, in the present embodiment, the connecting portion 21 may be formed by an injection molding process. Compared with other molding processes, forming the connecting portion 21 through the injection molding process can effectively reduce the molding difficulty of the connecting portion 21. The insertion cavity 21a and the auxiliary cavity 21b are both functional cavities formed by a molding die during the injection molding process. The second insert is a molding die for the insertion cavity 21a. The first insert serves as a support member for the second insert. The first insert enables the second insert to remain relatively stable during the injection molding process, thereby improving the molding yield of the insertion cavity 21a. Certainly, in other embodiments, the auxiliary cavity 21b and the insertion cavity 21a may also be implemented by other molding processes. It should be noted that, unless otherwise specified, in the embodiments herein, the insertion cavity 21a and the auxiliary cavity 21b are both formed by the molding die during the injection molding process of the connecting portion 21.

Optionally, the coupling end 250 of the electrical connector 25 may be fixed in the insertion cavity 21a by glue. Thus, the coupling end 250 of the electrical connector 25 is fixed in the connecting portion 21 under the action of the glue. The auxiliary cavity 21b is configured to accommodate a redundant portion of the glue, thereby preventing overflow of the glue.

Optionally, as shown in FIG. 5, when viewed from an exterior of the connecting portion 21, at least a portion of the insertion cavity 21a is arranged in a groove form. The earphone 1 further includes an elastic coating layer 32 covering a periphery of the connecting portion 21 and the metal member 31 and covering the insertion cavity 21a. To improve the molding precision of the insertion cavity 21a, a support portion needs to be provided on a peripheral side of the second insert. During the injection molding process, the second insert can be supported through the support portion and the first insert, preventing deformation and misalignment of the second insert. After the connecting portion 21 is formed, a portion of the insertion cavity 21a formed at a location corresponding to the support portion of the second insert is arranged in a groove form.

The elastic coating layer 32 covers the periphery of the connecting portion 21 and the metal member 31 and covers the insertion cavity 21a. Thus, the flexible coating layer can provide physical protection for the metal member 31, the connecting portion 21, and a circuit connector, thereby effectively improving the operational stability of the electrical connector 25 and the metal member 31.

Optionally, as shown in FIG. 5, the insertion cavity 21a includes a first cavity section 210, a second cavity section 211, and a third cavity section 212 sequentially communicating in a direction away from the accommodating cavity 220. The first cavity section 210 and the third cavity section 212 are arranged in a circumferentially closed form. The second cavity section 211 is arranged in a groove form.

Specifically, the second insert is the molding die for the insertion cavity 21a. During the molding process, the second insert is connected to a corresponding support portion to prevent the second insert from deforming during the injection molding of the connecting portion 21, thereby improving the final molding precision of the insertion cavity 21a. Arranging the first cavity section 210 and the third cavity section 212, located at the two ends of the second cavity section 211, in the circumferentially closed form enables the coupling end 250 of the electrical connector 25 to implement better circumferential positioning under the limiting action of the first cavity section 210 and the third cavity section 212, which effectively prevents the coupling end 250 of the electrical connector 25 from lifting relative to the connecting portion 21, thereby effectively improving the connection stability between the coupling end 250 of the electrical connector 25 and the connecting portion 21. The second cavity section 211 is a portion of the insertion cavity 21a formed based on the support portion of the second insert.

Optionally, the coupling end 250 of the electrical connector 25 is configured to be pre-embedded in the connecting portion 21 during the molding process of the connecting portion 21.

Specifically, different from the embodiment shown in FIG. 5 above, in the present embodiment, the electrical connector 25 participates in the molding process of the connecting portion 21. During the molding process of the connecting portion 21, the coupling end 250 of the electrical connector 25 is disposed in the molding die of the connecting portion 21. After molding liquid is injected into the molding die, the molding liquid encapsulates the coupling end 250 of the electrical connector 25, thereby enabling the coupling end 250 of the electrical connector 25 to be stably disposed inside the connecting portion 21.

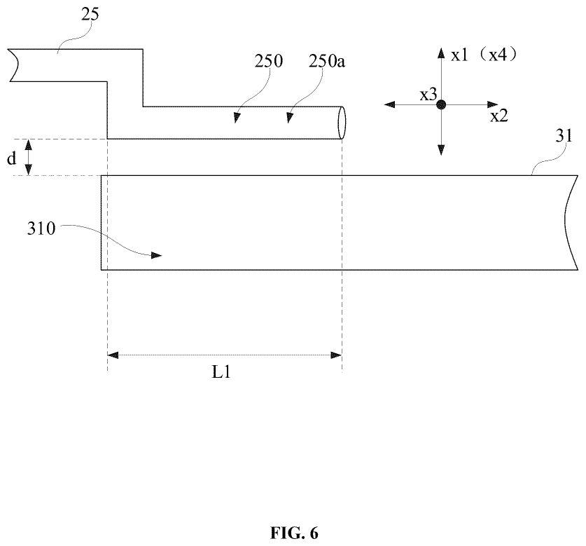

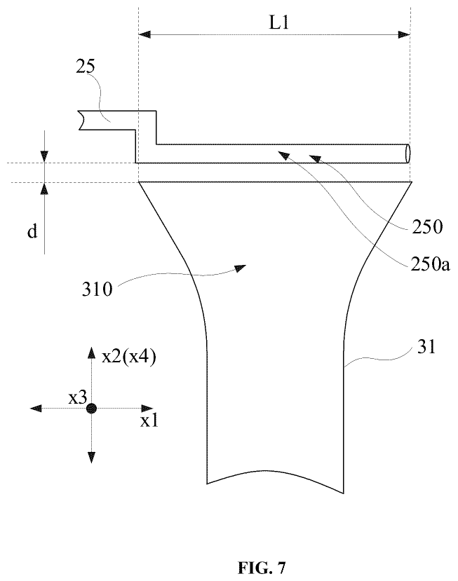

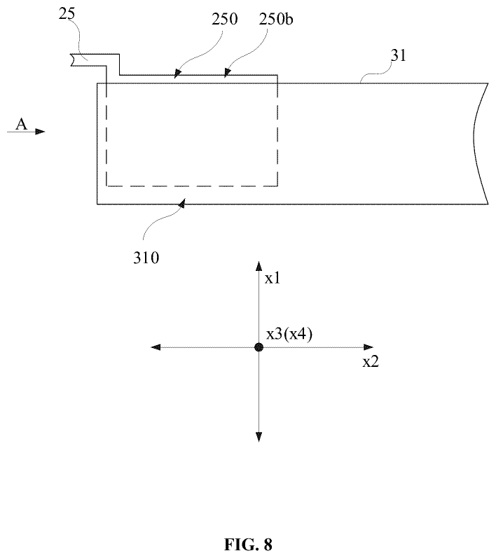

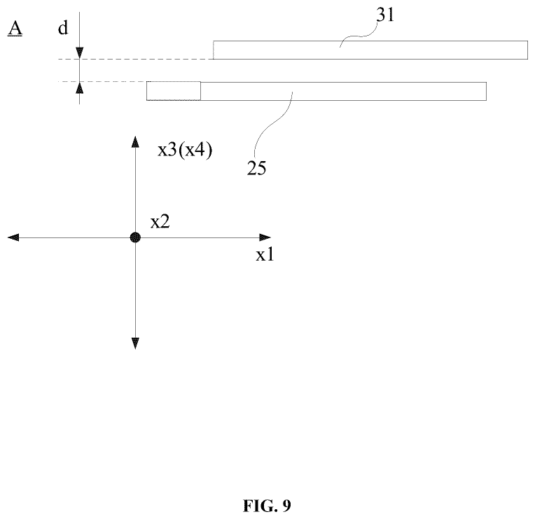

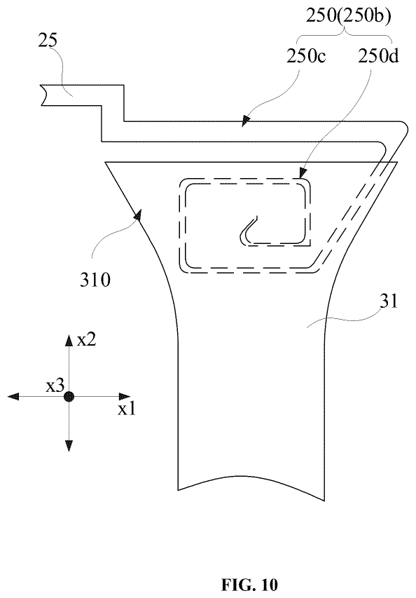

Optionally, as shown in FIG. 6, FIG. 7, FIG. 8, FIG. 9, and FIG. 10, the coupling end 250 of the electrical connector 25 is spaced apart from the metal member 31 along a predetermined interval direction x4. For example, as shown in FIG. 6, in some embodiments, the metal member 31 is arranged in a sheet form. The metal member 31 has a length direction x2, a width direction x1, and a thickness direction x3. The interval direction x4 may be the width direction x1 of the metal member 31. In other words, the coupling end 250 of the electrical connector 25 and the metal member 31 may be spaced apart along the width direction x1 of the metal member 31. Certainly, in other embodiments, as shown in FIG. 7, FIG. 8, FIG. 9, and FIG. 10, the interval direction x4 may also be the length direction x2 or the thickness direction x3 of the metal member 31. In other words, the coupling end 250 of the electrical connector 25 and the metal member 31 may also be spaced apart along the thickness direction x3 or the length direction x2 of the metal member 31.

A projection of the coupling end 250 of the electrical connector 25 along the interval direction x4 and the metal member 31 overlap with each other. An interval distance d between a projected overlapping portion of the coupling end 250 of the electrical connector 25 relative to the metal member 31 and the metal member 31 along the interval direction x4 is less than or equal to 1 mm, and an overlapping area s is greater than or equal to 1 mm². It should be noted that the thickness direction x3 refers to a direction perpendicular to a main surface of the metal member 31.

A coupling strength between the coupling end 250 of the electrical connector 25 and the coupling end 310 of the metal member 31 is positively correlated with the coupling coefficient k. The coupling coefficient k may be determined by Formula \textcircled{1} as follows:

$$k ∝ \frac{ε S}{d}$$

In the formula, k represents the coupling coefficient, which is referred to as the coupling coefficient k in the present disclosure; ε represents a dielectric constant; s represents the overlapping area s between the coupling end 250 of the electrical connector 25 and the coupling end 310 of the metal member 31, which is referred to as the overlapping area s in the present disclosure; d represents the interval distance d along the interval direction x4 between the projected overlapping portion of the coupling end 250 of the electrical connector 25 relative to the metal member 31 and the metal member 31, which is referred to as the interval distance d in the present disclosure.

Thus, the coupling end 250 of the electrical connector 25, the interval distance d, and the overlapping area s are factors affecting the electromagnetic coupling between the coupling end 250 of the electrical connector 25 and the coupling end 310 of the metal member 31. The interval distance d is negatively correlated with the coupling coefficient k. The overlapping area s is positively correlated with the coupling coefficient k. If the interval distance d is too large or the overlapping area s is too small, the coupling coefficient k will be weakened, thereby increasing the risk that the coupling end 250 of the electrical connector 25 and the coupling end 310 of the metal member 31 cannot implement the electromagnetic coupling.

Therefore, setting the interval distance d to be less than or equal to 1 mm and setting the overlapping area s to be greater than or equal to 1 mm² can make the coupling coefficient k fall within a relatively reasonable value range, thereby ensuring that the coupling end 250 of the electrical connector 25 and the coupling end 310 of the metal member 31 implement more efficient electromagnetic coupling and effectively improving the antenna performance of the antenna assembly. For example, the interval distance d may be set to be 0.5 mm, 0.6 mm, 1 mm, etc., which are actual values less than or equal to 1 mm. The overlapping area s may be set to be 1 mm², 2 mm², 3 mm², 4 mm², etc., which are actual values greater than or equal to 1 mm². It should be noted that the overlapping area s is also referred to as an overlapping area s between the coupling end 250 of the electrical connector 25 and the coupling end 310 of the metal member 31. In some embodiments herein, the overlapping area s is also referred to as an area between the projected overlapping portion of the coupling end 250 of the electrical connector 25 relative to the metal member 31 and the metal member 31 along the interval direction x4.

Optionally, as shown in FIG. 6, FIG. 7, FIG. 8, FIG. 9, and FIG. 10, a projection of the coupling end 250 of the electrical connector 25 along the interval direction x4 overlaps with the metal member 31. A ratio of the overlapping area s between the projected overlapping portion of the coupling end 250 of the electrical connector 25 relative to the metal member 31 and the metal member 31 along the interval direction x4 to the interval distance d is greater than or equal to 0.15 mm. For example, the ratio of the overlapping area s to the interval distance d may be 0.15 mm, 0.2 mm, 0.4 mm, 0.5 mm, etc., which are actual values greater than or equal to 0.15 mm. Based on this, the antenna performance of the antenna assembly can be effectively improved.

Optionally, as shown in FIG. 6 and FIG. 7, the metal member 31 is arranged in a sheet form. The coupling end 250 of the electrical connector 25 includes a columnar body 250a. In other words, the coupling end 250 of the electrical connector 25 may be the columnar body 250a configured in a columnar form.

As shown in FIG. 6, in some embodiments, the interval direction x4 between the coupling end 250 of the electrical connector 25 and the coupling end 310 of the metal member 31 is set as the width direction x1 of the metal member 31. Specifically, the columnar body 250a is spaced apart from the metal member 31 along the width direction x1. A projection of the columnar body 250a along the width direction x1 of the metal member 31 overlaps with the metal member 31. A length direction x2 of the columnar body 250a is the same as the length direction x2 of the metal member 31. Setting the length direction x2 of the columnar body 250a to be the same as the length direction x2 of the metal member 31 enables a length L1 of a projection of the columnar body 250a overlapping with the metal member 31 to be sufficiently long, so that an overlapping area s between the projection of the columnar body 250a along the width direction x1 and the metal member 31 is greater than or equal to 1 mm², thereby effectively improving the antenna performance of the antenna assembly.

As shown in FIG. 7, in some embodiments, the interval direction x4 between the coupling end 250 of the electrical connector 25 and the coupling end 310 of the metal member 31 is set as the length direction x2 of the metal member 31. Specifically, the columnar body 250a may also be spaced apart from the metal member 31 along the length direction x2 of the metal member 31. A projection of the columnar body 250a along the length direction x2 of the metal member 31 overlaps with the metal member 31. The length direction x2 of the columnar body 250a is the same as the width direction x1 of the metal member 31. Setting the length direction x2 of the columnar body 250a to be the same as the width direction x1 of the metal member 31 enables the length L1 of the projection of the columnar body 250a overlapping with the metal member 31 to be sufficiently long by widening a width of the coupling end 310 of the metal member 31, so that the overlapping area s between the projection of the columnar body 250a along the width direction x1 and the metal member 31 is greater than or equal to 1 mm², thereby effectively improving the antenna performance of the antenna assembly. Furthermore, spacing the columnar body 250a from the metal member 31 along the length direction x2 of the metal member 31 and setting the length direction x2 of the columnar body 250a to be the same as the width direction x1 of the metal member 31 can effectively reduce the spatial occupancy rate of the columnar body 250a in the regions on both sides of the metal member 31 along the width direction x1 while ensuring the overlapping area s between the columnar body 250a and the coupling end 310 of the metal member 31 along the length direction x2, thereby effectively reducing the structural size of the connecting portion 21 along the width direction x1.

Optionally, as shown in FIG. 6 and FIG. 7, the length L1 of the projection of the columnar body 250a overlapping with the metal member 31 is between 4 mm and 6 mm. The overlapping area s between the columnar body 250a and the coupling end 310 of the metal member 31 is not only positively correlated with the length L1 but also positively correlated with a radial dimension of the columnar body 250a. Therefore, setting the length L1 to be an actual value between 4 mm and 6 mm (e.g., 4 mm, 5 mm, or 6 mm) enables the radial dimension of the columnar body 250a to be set more reasonably while ensuring that the overlapping area s between the columnar body 250a and the coupling end 310 of the metal member 31 meets the requirement.

Optionally, as shown in FIG. 8, FIG. 9, and FIG. 10, the metal member 31 is arranged in a sheet form. The coupling end 250 of the electrical connector 25 includes a sheet body 250b. In other words, the coupling end 250 of the electrical connector 25 may be the sheet body 250b configured in a sheet form.

As shown in FIG. 8 and FIG. 9, in some embodiments, the interval direction x4 between the coupling end 250 of the electrical connector 25 and the coupling end 310 of the metal member 31 is set as the thickness direction x3 of the metal member 31. Specifically, the sheet body 250b is spaced apart along the thickness direction x3 of the metal member 31. A projection of the sheet body 250b along the thickness direction x3 of the metal member 31 and the metal member 31 overlap with each other. The main surface of the metal member 31 and a main surface of the sheet body 250b are arranged opposite to each other. Based on this, the sheet body 250b is located on one side of the metal member 31 along the thickness direction x3, thereby effectively reducing the spatial occupancy rate of the sheet body 250b in the spatial regions along the width direction x1 and the length direction x2 of the metal member 31, while also ensuring that the overlapping area s between the sheet body 250b and the coupling end 310 of the metal member 31 meets the requirement.

As shown in FIG. 10, in some embodiments, when viewed along a direction toward the main surface of the sheet body 250b, a projected overlapping portion of the sheet body 250b relative to the metal member 31 extends in a polyline shape. Specifically, the sheet body 250b includes a first line region 250c and a second line region 250d connected to the first line region 250c. The first line region 250c is located at an end of the coupling end 310 of the metal member 31 along the length direction x2 of the metal member 31 and is spaced apart opposite to the end of the coupling end 310 of the metal member 31. The second line region 250d extends from an end of the first line region 250c and extends to a region on one side of the coupling end 310 of the metal member 31 along the thickness direction x3.

Optionally, as shown in FIG. 3, the first housing assembly 24 further includes a first sub-housing 22. The first sub-housing 22 and the connecting portion 21 cooperate to form the accommodating cavity 220. The first sub-housing 22 and the connecting portion 21 are integrally formed or separately formed.

As shown in FIG. 3, in some embodiments, the first sub-housing 22 and the connecting portion 21 are separately formed. The connecting portion 21 is provided with an installation cavity 213 communicating with the accommodating cavity 220. The earphone includes the microphone 27. The microphone 27 may be disposed in the installation cavity 213. The connecting portion 21 is further provided with a sound pickup hole connecting the installation cavity 213 with an external space. Therefore, setting the first sub-housing 22 and the connecting portion 21 to be separately formed allows the first sub-housing 22 and the connecting portion 21 to be formed separately and then assembled. Based on this configuration, on one hand, the molding difficulty of the first sub-housing 22 and the connecting portion 21 can be effectively reduced. On the other hand, during the assembly process, components such as the microphone 27 can be placed into the installation cavity 213 before the connecting portion 21 is assembled with the first sub-housing 22, thereby effectively improving the assembly convenience of the microphone 27. Furthermore, the connecting portion 21 is a component connected to the metal member 31. After the connecting portion 21 is connected to the metal member 31, the flexible coating layer 32 needs to be formed on outer surfaces of the connecting portion 21 and the metal member 31 by a molding process. Compared with the first sub-housing 22 and the connecting portion 21 being integrally formed, setting the first sub-housing 22 and the connecting portion 21 to be separately formed allows the flexible coating layer 32 to be formed on the outer surfaces of the connecting portion 21 and the metal member 31 first, and then the connecting portion 21 to be assembled with the first sub-housing 22, which can effectively prevent the flexible coating layer 32 from adhering to an outer surface of the first sub-housing 22 when the flexible coating layer 32 is being formed on the outer surfaces of the connecting portion 21 and the metal member 31.

As shown in FIG. 3, the first housing assembly 24 further includes a second sub-housing 23. The first sub-housing 22, the second sub-housing 23, and the connecting portion 21 cooperate with each other to form the accommodating cavity 220.

The foregoing descriptions are merely partial embodiments of the present disclosure and are not intended to limit the scope of the present disclosure. Any equivalent device or equivalent process transformations made based on the content of the specification and drawings of the present disclosure, or direct or indirect application in other related technical fields, shall similarly fall within the patent protection scope of the present disclosure.

1. An earphone, comprising:
a first housing assembly;
a second housing assembly;
a metal member;
a radio frequency (RF) circuit; and
an electrical connector, wherein
two ends of the metal member are respectively connected to the first housing assembly and the second housing assembly;
the first housing assembly forms an accommodating cavity and includes a connecting portion, one end of the metal member being disposed in the connecting portion;
the RF circuit is disposed in the accommodating cavity, one end of the electrical connector being connected to the RF circuit and the other end of the electrical connector being spaced apart from the metal member; and
an RF signal output from the RF circuit is loaded onto the metal member in an electromagnetic coupling manner via the electrical connector.

2. The earphone of claim 1, wherein the other end of the electrical connector is disposed in the connecting portion.

3. The earphone of claim 2, wherein an insertion cavity communicating with the accommodating cavity is pre-formed on the connecting portion, and the other end of the electrical connector is inserted into the insertion cavity.

4. The earphone of claim 3, wherein an auxiliary cavity communicating with the insertion cavity and crossing the insertion cavity is pre-formed on the connecting portion.

5. The earphone of claim 4, wherein the other end of the electrical connector is fixed in the insertion cavity by glue, and the auxiliary cavity is configured to accommodate a redundant portion of the glue.

6. The earphone of claim 4, wherein the auxiliary cavity is formed by a first insert, and the first insert is configured to fix a second insert for forming the insertion cavity during a molding process of the connecting portion.

7. The earphone of claim 3, wherein
when viewed from an exterior of the connecting portion, at least a portion of the insertion cavity is arranged in a groove form.

8. The earphone of claim 7, wherein the insertion cavity comprises a first cavity section, a second cavity section, and a third cavity section sequentially communicating in a direction away from the accommodating cavity.

9. The earphone of claim 2, wherein the other end of the electrical connector is pre-embedded in the connecting portion during the molding process of the connecting portion.

10. The earphone of claim 1, wherein
the other end of the electrical connector is spaced apart from the metal member along a predetermined interval direction, and a projection thereof along the interval direction and the metal member overlap with each other; and
an interval distance between a projected overlapping portion of the other end of the electrical connector relative to the metal member and the metal member along the interval direction is less than or equal to 1 mm.

11. The earphone of claim 1, wherein
the metal member is arranged in a sheet form;
the other end of the electrical connector comprises a columnar body, wherein
a projection of the columnar body along a width direction of the metal member overlaps with the metal member; and
a length direction of the columnar body is the same as a length direction of the metal member.

12. The earphone of claim 11, wherein a length of the projection of the columnar body overlapping with the metal member is between 4 mm and 6 mm.

13. The earphone of claim 1, wherein
the metal member is arranged in a sheet form;
the other end of the electrical connector comprises a sheet body, wherein
a projection of the sheet body along a thickness direction of the metal member and the metal member overlap with each other; and
a main surface of the metal member and a main surface of the sheet body are arranged opposite to each other.

14. The earphone of claim 13, wherein
when viewed along a direction toward the main surface of the sheet body, a projected overlapping portion of the sheet body relative to the metal member extends in a polyline shape.

15. The earphone of claim 1, wherein the first housing assembly further comprises a first sub-housing, wherein the first sub-housing and the connecting portion cooperate to form the accommodating cavity, and the first sub-housing and the connecting portion are integrally formed or separately formed.

16. The earphone of claim 1, wherein
the other end of the electrical connector is spaced apart from the metal member along a predetermined interval direction, and a projection thereof along the interval direction and the metal member overlap with each other; and
a ratio of an overlapping area between a projected overlapping portion of the other end of the electrical connector relative to the metal member and the metal member along the interval direction to an interval distance is greater than or equal to 0.15.

17. The earphone of claim 1, wherein the earphone further comprises a sound generation assembly disposed in the second housing assembly, wherein in a wearing state
the second housing assembly is disposed in a concha cavity,
the first housing assembly abuts against a back side of an auricle,
the metal member is wound around a periphery of a helix,
the metal member is arranged in a sheet form,
one main surface of the metal member faces the auricle, and
the other main surface of the metal member faces away from the auricle.

18. The earphone of claim 3, wherein the earphone further comprises an elastic coating layer covering a periphery of the connecting portion and the metal member and covering the insertion cavity.

19. The earphone of claim 8, wherein the first cavity section and the third cavity section are arranged in a circumferentially closed form, and the second cavity section is arranged in a groove form.

20. The earphone of claim 10, wherein an overlapping area between the projected overlapping portion of the other end of the electrical connector relative to the metal member and the metal member along the interval direction is greater than or equal to 1 mm².
